(19) United States
(12) Patent Application Publication
(10) Pub. No.: US 2015/0223238 A1
(43) Pub. Date: Aug. 6, 2015

(54) METHOD FOR MANAGING NETWORK RESOURCES OF WIRELESS TERMINAL IN HETEROGENEOUS NETWORK ENVIRONMENT

(71) Applicant: ELECTRONICS AND TELECOMMUNICATIONS RESEARCH INSTITUTE, Daejeon (KR)

(72) Inventors: Jin Suk PAK, Gimhae-si (KR); Byung Jang JEONG, Daejeon (KR); Sung Jin YOO, Daejeon (KR); Jae Ick CHOI, Daejeon (KR)

(21) Appl. No.: 14/599,652

(22) Filed: Jan. 19, 2015

(30) Foreign Application Priority Data
Feb. 4, 2014 (KR) 10-2014-0012567

(51) Int. Cl. H04W 72/04; H04W 48/12; H04L 5/00

(52) U.S. Cl. CPC H04W 72/0446; H04L 5/0032; H04W 48/12; H04W 88/06

(57) ABSTRACT

Disclosed is a method for managing network resources of a wireless terminal in a heterogeneous network environment and the method for managing network resources includes: searching for one or more networks which are accessible in the heterogeneous network environment; acquiring cycle information of the networks searched through the network searching; determining coexistence management cycles of the searched networks based on the cycle information; allocating one or more networks to be used in data transmission among the networks searched according to the coexistence management cycle and determining transmission management cycles of one or more allocated networks; and managing a resource of the searched network according to the coexistence management cycle and the transmission management cycle.

### CROSS-REFERENCE TO RELATED APPLICATIONS

This application claims priority to and the benefit of Korean Patent Application No. 10-2014-0012567 filed in the Korean Intellectual Property Office on Feb. 4, 2014, the entire contents of which are incorporated herein by reference.

### TECHNICAL FIELD

The present invention relates to a method for managing network resources of a wireless terminal in a heterogeneous network environment, which manages accessible network resources in order to perform cooperative transmission by using two or more heterogeneous networks in a heterogeneous network environment.

### BACKGROUND ART

At present, radio traffic serviced through wireless transmission technology are explosively increasing. In order to meet the radio traffic service requirements, the development of new wireless transmission technologies such as multiple input multiple output (MIMO), multi user MIMO (MU-MIMO), orthogonal frequency division multiple access (OFDMA), and the like, broadening of a bandwidth used in the wireless transmission technologies, discovery of a new frequency to be used in the wireless transmission technologies, and the like are in progress. However, the development of the wireless transmission technologies has reached a limit, and a method for increasing the efficiency of the wireless transmission technology provided presently through removal or management of radio interference or increasing usage efficiency by recognizing a situation of a frequency being used is presented as a new alternative.

The wireless transmission technologies serviced at present include Wi-Fi, Bluetooth, Wibro, wideband code division multiple access (WCDMA), long term evolution (LTE), and the like, and the technologies use different transmission technologies or different wireless access schemes.

These heterogeneous networks independently constitute the network to provide a wireless transmission service, but the respective heterogeneous networks may be independently serviced according to regions, time, bands of radio resources or serviced with coexistence. For example, when a wireless terminal such as a smart phone provides an LTE network access function with a Wi-Fi network, the wireless terminal may access both networks or access only one network according to a region. In this case, when the wireless terminal may access both the Wi-Fi network and the LTE network and receives respective services from both networks, such an environment may be defined as heterogeneous network environments in which two or more different wireless communication technologies coexist.

The heterogeneous network environments are shown in the case where serviced regions and times are the same as each other when the same base station services different wireless transmission technologies or different base stations service different wireless transmission technologies. Business operators that service the heterogeneous networks may be the same business operator or not the same business operator.

Wireless terminals which are operable in the heterogeneous network environments should be mounted with wireless transmission technologies that may access the heterogeneous networks, respectively, and the accessible networks depend on the mounted wireless transmission technologies. The heterogeneous networks have different features including a wireless access scheme, a data transmission method, a data transmission cycle, a maximum transmission amount, and the like according to the wireless transmission technologies. That is, the wireless terminal that may access the heterogeneous networks may perform cooperative transmission by using the heterogeneous networks simultaneously, but a discussion about a method for simultaneously using the heterogeneous networks is insufficient. A discussion for a method for effectively using resources of the respective heterogeneous networks is also required at the time of transmitting information by using the respective heterogeneous networks.

### SUMMARY OF THE INVENTION

The present invention has been made in an effort to provide a method for managing network resources of a wireless terminal in a heterogeneous network environment, which manages accessible network resources in order to perform cooperative transmission by using two or more heterogeneous networks in a heterogeneous network environment.

An exemplary embodiment of the present invention provides a method for managing network resources of a wireless terminal in a heterogeneous network environment, including: searching for one or more networks which are accessible in the heterogeneous network environment; acquiring cycle information of the networks searched through the network searching; determining coexistence management cycles of the searched networks based on the cycle information; allocating one or more networks to be used in data transmission among the networks searched according to the coexistence management cycle and determining transmission management cycles of one or more allocated networks; and managing a resource of the searched network according to the coexistence management cycle and the transmission management cycle.

In the acquiring of the cycle information, the cycle information of the corresponding network may be extracted, which is included in synchronization data transmitted from the searched networks.

The synchronization data may be any one of a beacon frame, a reference signal, a pilot signal, and a synchronization signal.

The cycle information may include a frame transmission cycle, a network synchronization time, and a superframe cycle.

In the determining of the coexistence management cycle, a minimum common multiple of a cycle for each searched network may be calculated to be determined as the coexistence management cycle.

In the determining of the coexistence management cycle, the searched networks may be separated into two or more groups and the coexistence management cycle may be created for each of the separated groups.

The determining of the coexistence management cycle may include: verifying whether a cycle interval is changeable for the respective searched networks; requesting changing the cycle to the corresponding network when a network in which the cycle interval is changeable exists; determining, when the cycle of the corresponding network is changed according to the cycle change request, the coexistence management cycle based on the changed cycle information; verifying whether a cycle start time of the corresponding network is changeable; requesting changing the cycle start time to the corresponding network when the cycle start time is changeable; and determining a start time of the coexistence management cycle based on the cycle start time changed by the request for changing the cycle start time.

The cycle of the network may be changed by considering the transmission quality of the corresponding network.

In the determining of the transmission management cycle, a maximum common denominator of the cycle for each allocated network may be calculated to be determined as the transmission management cycle.

The method may further include: re-searching an accessible network for every coexistence management cycle and collecting transmission quality information of the re-searched network; and predicting a serviceable transmission quality of the re-searched network during a subsequent coexistence management cycle based on the transmission quality information.

The transmission quality information may include a signal to interference plus noise ratio, frame error rate (FER), bit error rate (BER), a delay, an interference level, and transmission power.

The serviceable transmission quality may include a transmission stand-by buffer, a transmissible time, transmissible transmission power, a maximum transmission amount, and a transmission delay time.

According to exemplary embodiments of the present invention, accessible network resources can be managed in order to perform cooperative transmission by using two or more heterogeneous networks in a heterogeneous network environment.

Accordingly, a coexistence management cycle can be created when two or more networks intend to be simultaneously used under a situation in which a plurality of heterogeneous networks coexists, and the network resources can be efficiently managed based on the coexistence management cycle.

Data processing rate can be increased through cooperative transmission management using the heterogeneous networks.

A transmission load can be effectively distributed when network congestion occurs in the heterogeneous network environment.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

Objects of the present invention are not limited the aforementioned object and other objects and advantages of the present invention, which are not mentioned can be appreciated by the following description and will be more apparently know by the exemplary embodiments of the present invention. It can be easily known that the objects and advantages of the present invention can be implemented by the means and a combination thereof described in the appended claims.

### BRIEF DESCRIPTION OF THE DRAWINGS

FIG. 1 is a configuration diagram schematically illustrating a heterogeneous network based wireless communication system according to the present invention.

FIG. 2 is a configuration block diagram of a wireless terminal according to the exemplary embodiment of the present invention.

FIG. 3 is a flowchart illustrating a method for managing network resources of a wireless terminal in a heterogeneous network environment according to an exemplary embodiment of the present invention.

FIG. 4 is an exemplary diagram illustrating a method for determining a coexistence management cycle and a transmission management cycle according to an exemplary embodiment of the present invention.

FIG. 5 is an exemplary diagram illustrating a method for setting an offset time of a management cycle according to an exemplary embodiment of the present invention.

FIG. 6 is a flowchart illustrating a method for determining a coexistence management cycle illustrated in FIG. 3.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings.

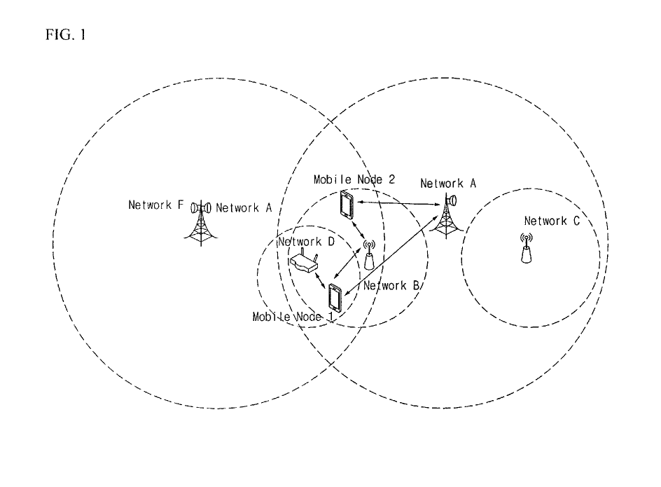

FIG. 1 is a configuration diagram schematically illustrating a heterogeneous network based wireless communication system according to the present invention.

The wireless communication system may be constituted by one or more wireless terminals or one or more relay devices in a heterogeneous network environment in which two or more networks using different wireless transmission and access technologies coexist. Herein, the wireless terminal commonly refers to user terminals including a mobile node (MN), a mobile terminal, a communication apparatus, a smart phone, a tablet, and the like, and the relay device commonly refers to a base station and an access point (AP).

Referring to FIG. 1, a first wireless terminal (mobile node 1, MN 1) exists in a heterogeneous network region in which networks A, B, C, D, and F coexist. In this case, when the first mobile node MN1 includes communication modules that may access the networks A, B, and D, respectively, the first mobile node MN1 may use the networks A, B, and D simultaneously. The networks A, B, and D may be defined as coexistence heterogeneous networks for the first mobile node MN1. Herein, when the first mobile node MN1 moves to a position of a second mobile node MN2, the coexistence heterogeneous network for the first mobile node MN1 become the networks A and B.

The mobile nodes MN1 and MN2 use the wireless transmission technology when the mobile nodes MN1 and MN2 access one or more networks or need data transmission and reception in an accessible state. In this case, the mobile nodes MN1 and MN2 operate in the corresponding network according to an access scheme and a transmission technology of an accessible network and a transmission amount depends on a transmission quality of the corresponding network. The transmission quality of the network varies depending on various environmental factors including a transmission delay, a maximum transmission amount, the number of simultaneous users, frequency interference, a transmission speed, a usage reward, and the like as well as a difference depending on the wireless transmission technology and the access scheme. Accordingly, whether the wireless terminal satisfies the wireless transmission service is determined by the transmission quality of the network. In this case, the wireless terminal that may use two or more heterogeneous networks simultaneously may satisfy the quality of service (QoS) by using the heterogeneous networks that coexist in addition to a network which is being used at present.

If a data transmission requirement is generated according to a usage service by the mobile nodes MN1 and MN2 and the data transmission requirement may not be satisfied in the accessing network, the data transmission requirement may be satisfied by using the heterogeneous networks which coexist.

Therefore, in the present invention, the coexistence management cycle (coexistence cycle) and the transmission management cycle (transmission cycle) between the heterogeneous networks are created to perform resource distribution of the heterogeneous networks at a management cycle unit for effective network resource management upon the cooperative transmission using the coexistence heterogeneous networks.

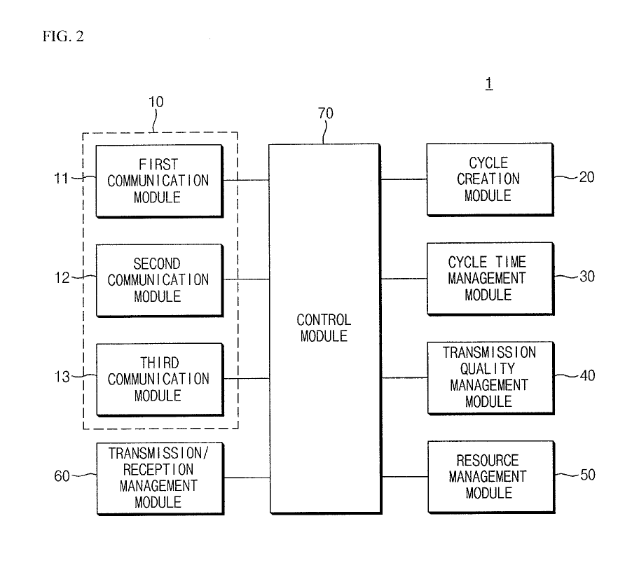

FIG. 2 is a configuration block diagram of a wireless terminal according to the exemplary embodiment of the present invention.

Referring to FIG. 2, the wireless terminal 1 includes a network module 10, a cycle creation module 20, a cycle time management module 30, a transmission quality management module 40, a resource management module 50, a transmission/reception management module 60, and a control module 70.

The network module 10 may include two or more communication modules for accessing different networks, respectively, that is, a first communication module 11, a second communication module 12, and a third communication module 13. For example, the first communication module 11 is used to access a wireless broadband Internet (Wibro) network, the second communication module 12 is used to access a wireless local area network (WLAN), and the third communication module 13 is used to access a long term evolution (LTE) network. In the exemplary embodiment, the case where the wireless terminal 1 includes three communication modules is described as an example, but the present invention is not limited thereto and the wireless terminal 1 may include more communication modules.

The network module 10 searches for one or more networks which are accessible in the heterogeneous network environment. That is, when the network module 10 receives a synchronization signal through the first communication module 11 to the third communication module 13, the network module 10 selects a network corresponding to the synchronization signal as the accessible network.

The cycle creation module 20 creates the coexistence management cycle and the transmission management cycle for resource managements of the searched networks. The cycle creation module 20 manages maintenance and new generation of the heterogeneous networks that coexist according to the coexistence management cycle.

The cycle time management module 30 calculates cycle start times of the management cycles created by the cycle creation module 20 and an offset time for each network.

The transmission quality management module 40 monitors the transmission quality for each network searched during the transmission cycle.

The resource management module 50 selects one or more networks to be used among the searched networks and determines a transmission amount which is usable for each network. That is, the resource management module 50 serves to manage and allocate (distribute) the network resources. For example, the resource management module 50 selects the communication module (11, 12, or 13) among the communication modules 11 to 13 and determines a data amount which may be transmitted for each selected communication module.

The transmission/reception management module 60 transmits/receives data by using the resources allocated by the resource management module 50. For example, the transmission/reception management module 60 transmits the data through the first communication module 11 when the first communication module 11 is allocated by the resource management module 50. Alternatively, the transmission/reception management module 60 distributes data to be transmitted according to transmission amounts allocated to the first, second, and third communication modules 11, 12, and 13.

The control module 70 controls an overall operation of the wireless terminal 1 by controlling the components.

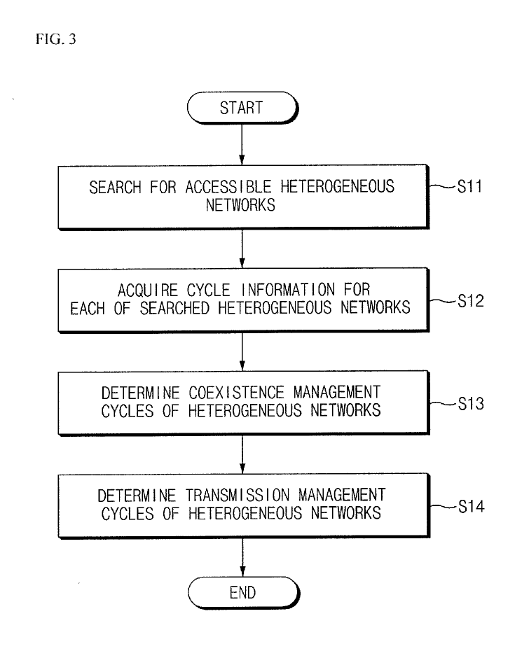

FIG. 3 is a flowchart illustrating a method for managing network resources of a wireless terminal in a heterogeneous network environment according to an exemplary embodiment of the present invention.

First, the wireless terminal 1 searches for one or more networks which are accessible in the heterogeneous network environment in which two or more heterogeneous networks coexist (S1). In this case, the wireless terminal 1 receives synchronization data transmitted from relay devices (e.g., a base station, an access point, and the like) in the network. For example, the synchronization data may be a beacon frame, a reference signal, a pilot signal, a synchronization signal, and the like.

The wireless terminal 1 acquires cycle information for each searched network (S12). That is, the wireless terminal 1 extracts the cycle information included in the received synchronization data. The cycle information may include information such as a frame transmission cycle for each network, a network synchronization time, and a superframe cycle.

The wireless terminal 1 determines a coexistence management cycle for managing the networks searched based on the acquired cycle information for each network (S13).

The wireless terminal 1 allocates one or more networks to be used for data transmission among the searched networks when the coexistence management cycle is determined, and determines the transmission management cycle for transmission schedule management through one or more allocated networks (S14).

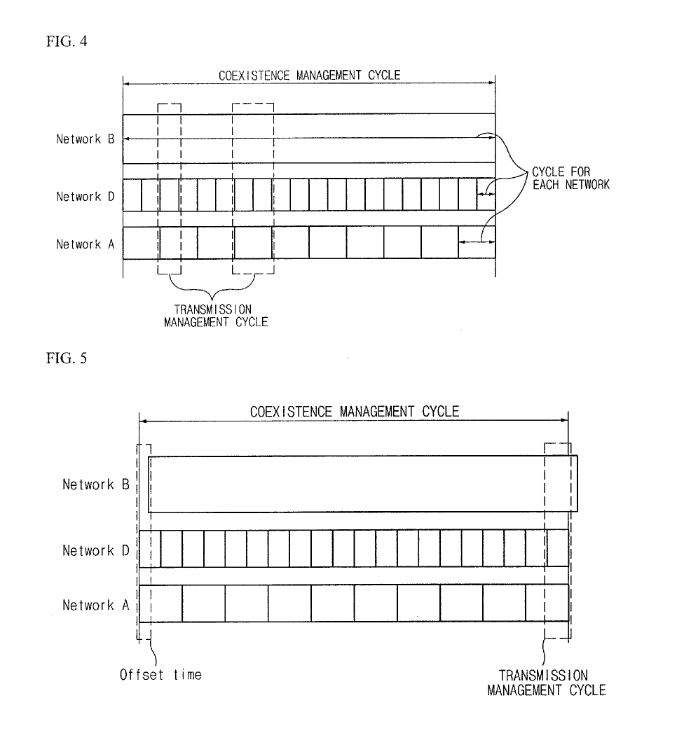

FIG. 4 is an exemplary diagram illustrating a method for determining a coexistence management cycle and a transmission management cycle according to an exemplary embodiment of the present invention.

The wireless terminal 1 searches for a network which is accessible at a site at which the wireless terminal 1 is positioned, and acquires cycle information for each searched network. The wireless terminal 1 determines a coexistence management cycle and a transmission management cycle based on the cycle information for each network.

In this case, the wireless terminal 1 calculates a minimum common multiple of a cycle for each network to determine the calculated minimum common multiple as the coexistence management cycle. The wireless terminal 1 calculates a maximum common denominator of the cycle for each network to determine the calculated maximum common denominator as the transmission management cycle.

For example, when cycles of the networks A, B, and D are 10 ms, 100 ms, and 5 ms, respectively, the wireless terminal 1 calculates a minimum common multiple and a maximum common denominator of 10 ms, 100 ms, and 5 ms, and determines 100 ms which is the calculated minimum common multiple, and 5 ms which is the calculated maximum common denominator, as the coexistence management cycle and the transmission management cycle, respectively.

The wireless terminal 1 selects all searched networks or only some of the searched networks to calculate and manage the coexistence management cycle and the transmission management cycle of the corresponding networks.

The wireless terminal 1 may separate the searched networks into two or more groups and create the transmission management cycle for each group.

FIG. 5 is an exemplary diagram illustrating a method for setting an offset time of a management cycle according to an exemplary embodiment of the present invention.

An interval of the determined coexistence management cycle is maintained as a fixed value by using the cycle information acquired for each searched network, but a start time of the coexistence management cycle may vary for each network.

Accordingly, the cycle time management module 30 of the wireless terminal 1 selects any one network among the searched networks to set a cycle start time of the selected network as a reference of the coexistence management cycle. The cycle time management module 30 compensates for a difference in cycle start time between the network set as the reference and the residual networks through setting the offset time.

In this case, the wireless terminal 1 selects as the reference network a network having a smallest cycle interval among the searched heterogeneous networks. The wireless terminal 1 compares cycle start times of different heterogeneous networks that exist based on the cycle start time of the selected network. The wireless terminal 1 sets ‘−offset time’ when the cycle start times of different heterogeneous networks are earlier than a reference cycle time, and ‘+offset time’ when the cycle start times are later than the reference cycle time.

The wireless terminal 1 determines cycle start times of the searched networks so that the interval of the offset time is smallest. The wireless terminal 1 selects one of the cycle start times of the searched networks to make one selected cycle start time coincide with the start time of the coexistence management cycle. In this case, when an intermediate value is selected among the cycle start times of the searched networks, a minimum offset time may be provided before and after the selected cycle start time and another cycle start time may be selected as necessary.

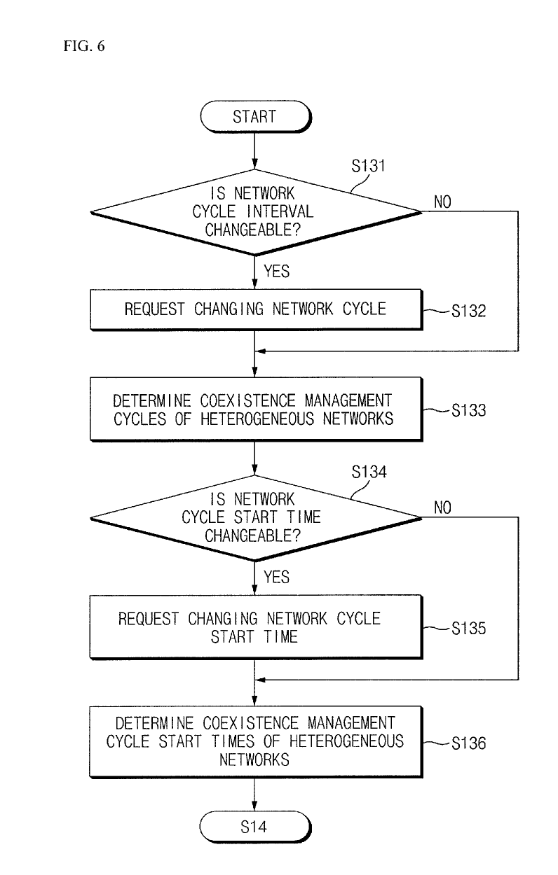

FIG. 6 is a flowchart illustrating a method for determining a coexistence management cycle illustrated in FIG. 3.

First, the wireless terminal 1 verifies whether the cycle interval of the network is changeable (S131). In this case, the wireless terminal 1 verifies whether the cycle interval is changeable in respect to the searched networks.

The wireless terminal 1 requests changing the cycle of the network when the cycle interval of the network is changeable (S132).

When the network cycle is changed, the wireless terminal 1 determines a coexistence management cycle based on the changed network cycle and the acquired cycle information (S 133). When the cycle interval of the network may not be changed in step S131, the wireless terminal 1 determines the coexistence management cycle based on the cycle information acquired in step S12.

For example, when it is assumed that the cycle of the network B is 100 ms, the cycle of the network D is 160 ms, and the cycle of the network A is 10 ms, the coexistence management cycle is 800 ms and the transmission management cycle is 10 ms. In this case, if the cycle of the network B is changed, the cycle of the network B is requested to be changed to 80 ms and thereafter, when the cycle of the network B is changed to 80 ms, the coexistence management cycle may be controlled to 160 ms.

In this case, since the cycle control influences even the performance of the network, the cycle is unconditionally changed but the cycle should be changed by considering the transmission qualities of the heterogeneous networks which coexist.

The wireless terminal 1 verifies whether the cycle start time of the network is changeable (S134).

When the cycle start time of the network is changeable, the wireless terminal 1 requests changing the cycle start time of the network to the relay device of the corresponding network (S135).

The wireless terminal 1 determines the coexistence management cycle start times of the networks based on the changed cycle start time (S136). When the cycle start time of the network cannot be changed, the wireless terminal 1 determines the coexistence management cycle start times of the heterogeneous networks by using only the acquired cycle information.

When the coexistence management cycle and the transmission management cycle are created through such a procedure, the wireless terminal 1 manages the network resources according to the coexistence management cycle and the transmission management cycle.

The wireless terminal 1 searches for heterogeneous networks (accessible networks) which coexist for every coexistence management cycle, and verifies whether coexistence information of the searched heterogeneous networks is maintained. For example, when the first mobile node MN1 of FIG. 1 moves to the position of the second mobile node MN2, the first mobile node MN1 deviates from a service area of the network D, and as a result, the heterogeneous networks which coexist are changed. The wireless terminal 1 monitors whether the heterogeneous networks which coexist are changed for every coexistence management cycle.

The transmission quality management module 40 of the wireless terminal 1 collects transmission quality information of the respective heterogeneous networks for every coexistence management cycle. The transmission quality information includes a signal to interference plus noise ratio (SINR), frame error rate (FER), bit error rate (BER), a delay, an interference level, transmission power, and the like, which are collected in various forms during the coexistence management cycle.

The transmission quality management module 40 predicts transmission qualities which are serviceable in the respective heterogeneous networks during a subsequent coexistence management cycle based on the collected transmission quality information. The predicted transmission quality may include a transmission stand-by buffer, a transmissible time, transmissible transmission power, a maximum transmission amount, a transmission delay time, and the like. The resource management module 50 of the wireless terminal 1 may manage resource allocation and cooperative transmission for each of the heterogeneous networks based on the transmission quality information.

For example, when congestion occurs in any one network of the heterogeneous networks which coexist, the transmission load may be distributed to another network having small congestion, and even when a service network moves among the heterogeneous networks which coexist, a transmission path may be changed according to the coexistence management cycle even in a service cutoff situation such as a handover among the heterogeneous networks.

That is, the heterogeneous networks which coexist may be searched, configured, and managed by using the coexistence management cycle of the heterogeneous networks, and resource management for the cooperative transmission and transmission load management based on the transmission qualities of the heterogeneous networks may be performed for each cycle unit.

The transmission management cycle of the heterogeneous networks is a cycle in which actual data transmission is performed according to the wireless transmission scheme or the wireless access scheme of the corresponding heterogeneous networks when whether the resource is allocated or the heterogeneous networks are used is determined according to the coexistence management cycle.

That is, an overall resource allocation strategy serviceable within the coexistence management cycle is achieved according to the coexistence management cycle of the heterogeneous networks, and when transmitted data are distributed and downloaded to respective communication modules according to the resource allocation strategy, data transmission management using the respective communication modules is performed based on the transmission management cycle within the coexistence cycle.

The transmission management cycle of the heterogeneous networks may be included in the coexistence management cycle and may coincide with the coexistence management cycle according to the heterogeneous networks which coexist.

The data transmission may be performed by independently using the first to third communication modules 11 to 13 which coexist during the transmission management cycle, and the cooperative transmission may be performed by simultaneously using the first to third communication modules 11 to 13.

The transmission management cycles of the heterogeneous networks are the same as each other, and a first or finally allocated transmission management cycle is variable according to the offset times of the coexistence cycles of the heterogeneous networks.

What is claimed is:

1. A method for managing network resources of a wireless terminal in a heterogeneous network environment, the method comprising:
searching for one or more networks which are accessible in the heterogeneous network environment;
acquiring cycle information of the networks searched through the network searching;
determining coexistence management cycles of the searched networks based on the cycle information;
allocating one or more networks to be used in data transmission among the networks searched according to the coexistence management cycle and determining transmission management cycles of one or more allocated networks; and
managing a resource of the searched network according to the coexistence management cycle and the transmission management cycle.

2. The method of claim 1, wherein in the acquiring of the cycle information, the cycle information of the corresponding network is extracted, which is included in synchronization data transmitted from the searched networks.

3. The method of claim 2, wherein the synchronization data is any one of a beacon frame, a reference signal, a pilot signal, and a synchronization signal.

4. The method of claim 2, wherein the cycle information includes a frame transmission cycle, a network synchronization time, and a superframe cycle.

5. The method of claim 1, wherein in the determining of the coexistence management cycle, a minimum common multiple of a cycle for each searched network is calculated to be determined as the coexistence management cycle.

6. The method of claim 1, wherein in the determining of the coexistence management cycle, the searched networks are separated into two or more groups and the coexistence management cycle is created for each of the separated groups.

7. The method of claim 1, wherein the determining of the coexistence management cycle includes:
verifying whether a cycle interval is changeable for the respective searched networks;
requesting changing the cycle to the corresponding network when a network in which the cycle interval is changeable exists;
determining, when the cycle of the corresponding network is changed according to the cycle change request, the coexistence management cycle based on the changed cycle information;
verifying whether a cycle start time of the corresponding network is changeable;
requesting changing the cycle start time to the corresponding network when the cycle start time is changeable; and
determining a start time of the coexistence management cycle based on the cycle start time changed by the request for changing the cycle start time.

8. The method of claim 7, wherein the cycle of the network is changed by considering the transmission quality of the corresponding network.

9. The method of claim 1, wherein in the determining of the transmission management cycle, a maximum common denominator of the cycle for each allocated network is calculated to be determined as the transmission management cycle.

10. The method of claim 1, further comprising:
re-searching an accessible network for every coexistence management cycle and collecting transmission quality information of the re-searched network; and
predicting a serviceable transmission quality of the re-searched network during a subsequent coexistence management cycle based on the transmission quality information.

11. The method of claim 10, wherein the transmission quality information includes a signal to interference plus noise ratio, frame error rate (FER), bit error rate (BER), a delay, an interference level, and transmission power.

12. The method of claim 10, wherein the serviceable transmission quality includes a transmission stand-by buffer, a transmissible time, transmissible transmission power, a maximum transmission amount, and a transmission delay time.
